(19) United States
(12) Patent Application Publication
(10) Pub. No.: US 2008/0111422 A1
(43) Pub. Date: May 15, 2008

(54) Voltage Regulator and Power System with a Voltage Boost for a Low Input Voltage

(76) Inventor: Floyd M. Minks, Brinson, GA (US)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(21) Appl. No.: 11/859,836

(22) Filed: Sep. 24, 2007

Related U.S. Application Data
(60) Provisional application No. 60/827,799, filed on Oct. 2, 2006.

(51) Int. Cl. H02J 3/02; H02J 3/00

(52) U.S. Cl. 307/41

(57) ABSTRACT

An electrical system for supplying a DC voltage regulated to a desired level to a DC load is provided, wherein power is obtained from an AC waveform that under some conditions has a peak value below the desired level of eth DCC voltage. The AC waveform is connected to the AC load through a first solid state switch, wherein the magnitude of the DC voltage is controlled by a second solid state switch. Monitoring and control circuitry is provided to ensure that the first solid state switch is not turned off unless the second solid state switch is turned on. As a result, the electrical system may produce a nominal 12 volts DC output of sufficient current to desirably operate a multifunction gauge which otherwise might operate at varying voltage levels based on engine rpm variations.

### CROSS-REFERENCE TO RELATED APPLICATIONS

This application claims priority to and the benefit of U.S. Provisional Application No. 60/827,799, filed Oct. 2, 2006, the disclosure of which is hereby incorporated by reference herein in its entirety and commonly owned.

### FIELD OF THE INVENTION

The present invention generally relates to power systems, and more particularly to a system and method for supplying AC and regulated DC voltages from an alternator to separate AC and DC loads.

### BACKGROUND OF THE INVENTION

Typically, headlights and other major electrical loads are supplied with a nominal 12 volts AC at normal operating speeds. However, at idle conditions, this voltage typically drops to a half value or less of such a rated voltage. Snowmobiles and other small recreational vehicles such as four wheelers typically have an electrical system having an alternator, usually the permanent magnet type, attached to the engine, and thus operating at varying speeds and frequencies with engine rpm variations. As illustrates by way of example with reference to FIG. 1, this alternator A is typically attached to a voltage regulator to control the AC voltage such as described in U.S. Pat. No. 5,672,955, the disclosure of which is incorporated herein by reference in its entirety. With continued reference to FIG. 1, an arrangement of various headlamps and tail lamps shown as HL1 HL2 & TL are typically connected without switches. They are thus on at all times the vehicle engine is running. Various other loads represented by r_{L} may be controlled by switches such as S₁.

As is typical in the industry today, the size of the alternator A is sufficient to produce a rated voltage on the connected loads when the vehicle is moving, engine speed being above the point that it would typically be at a clutch engagement. However, it is common in the industry at engine idle speed for the voltage produced by the alternator A to be less than half the rated voltage. As a result, the lamps HL, TL are quite dim under idle conditions with the vehicle stationary. For both safety and marketing reasons, it is desirable to show vehicle speed in some of these vehicles gauges and other parameters such as transmission status, fuel level, and four wheel drive engagement. These are a few examples of many possible functions of a multi function gauge. Typically gauges of this type are used on vehicles with a 12 volt DC electrical system to supply constant power to the gauge. Frequently these gauges contain microprocessor electronics that must be supplied power continually to function properly. While it is technically possible to redesign these gauges to work from a voltage lower than 12 volts DC, it is neither economically desirable nor necessarily feasible because of the very high quantities already in production for other applications such as automotive at nominal 12 volt DC. Thus, there is a need to modify the electrical system shown in FIG. 1, by way of example, so as to produce a nominal 12 volts DC output of sufficient current to operate a multifunction gauge.

### SUMMARY OF THE INVENTION

The present invention provides a voltage regulator and power system and method useful with low power loads. One embodiment may comprise a system for supplying a DC voltage regulated to a desired level to a DC load, wherein power is obtained from an AC waveform that under some conditions has a peak value below the desired level of eth DCC voltage. The AC waveform may be connected to the AC load through a first solid state switch, wherein the magnitude of the DC voltage may be controlled by a second solid state switch. Monitoring and controls means is provided to ensure that the first solid state switch is not turned off unless the second solid state switch is turned on.

Methods of supplying direct current power for low power loads such as instrumentation on vehicles such as snowmobiles are provided wherein the electrical system primarily includes alternating current power. Embodiments of the invention may include a system for supplying AC and regulated DC voltages from an alternator to separate AC and DC loads, with the regulated DC voltage being greater than the alternator zero to peak voltage under some conditions. The system may contain an inductor and a solid state switch, with the switch operated by a control circuit to transfer energy stored in the inductor to the DC load, the inductor may be the inductance of the alternator. The system may include a solid state switch interrupting the flow of current from the alternator to the AC load. Embodiments provide means for supplying a nominal 12 volts DC for gauges and similar loads even though the peak value of the AC is below that level.

### BRIEF DESCRIPTION OF THE DRAWINGS

For a fuller understanding of the invention, reference is made to the following detailed description, taken in connection with the accompanying drawings in which:

FIG. 1 is a diagrammatical circuit diagram illustrating one typical circuit including an alternator attached to a voltage regulator for controlling AC voltage to various devices including headlamps and tail lamps, by way of example;

FIG. 2 is a diagrammatical circuit diagram illustrating one embodiment of a voltage regulator and power system in keeping with the teachings of the present invention; and

FIG. 3 is a partial diagrammatical circuit illustrating an alternate embodiment for the circuit of FIG. 2.

### DETAILED DESCRIPTION OF THE PREFERRED EMBODIMENTS

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

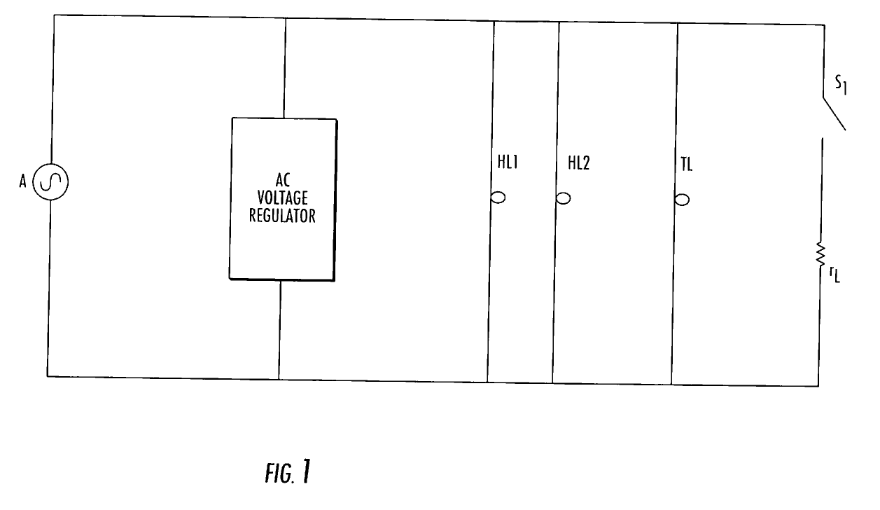

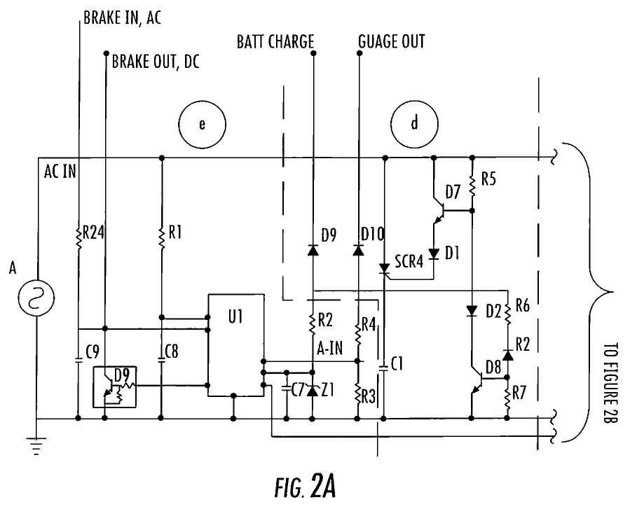

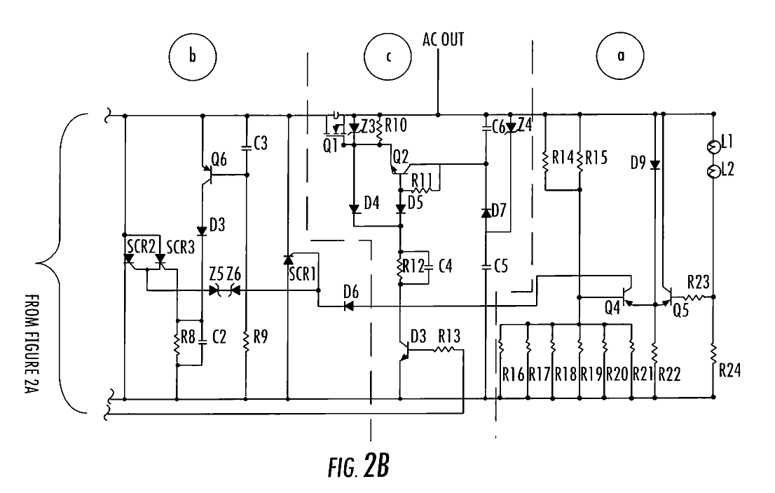

By way of example and with reference to FIG. 2, a system and method are provided for supplying power to a gauge requiring a steady DC voltage above the zero to peak voltage supplied by the alternator A under some rpm conditions. By way of example and for clarity of explanation, FIG. 2 is divided into 5 blocks labeled “a” through “e.” The line labeled AC out should be understood as being connected to the components shown as HL1, HL2, TL, and S1 & r_{L} in FIG. 1. The line marked “gauge out” should be understood as being connected to a multifunction gauge or speedometer. Vehicles of the type previously described, even though manual start is shipped from the factory, may have a field installed kit including a battery and electric starter. The lead marked “batt charge” may optionally be connected for charging a battery. Multifunction gauges may have an indicator identifying that the brake has been applied, which typically would require a DC source or sink signal. This may be connected to the line marked “brake out (DC).” Typically, the brake light itself would be part of the AC vehicle system with a switch operated by the brake lever in series with the bulb from the AC out to ground. Thus, this would produce an input signal for a microprocessor or control circuit L1. Circuits a and b together comprise the function of the AC shunt regulator shown in the '955 patent previously referenced. However in this case, section a has been split off from section b by the intervening components effectively becoming what is known as a remote sense. Zener diodes Z5 & Z6 have been added to force SCR1 or SCR2 to turn on if the peak voltage across the alternator A exceeds a desired level, thus protecting peak voltage sensitive components whether within or without of this circuit. Component designations in FIG. 2 are well understood by those of ordinary skill in the art and do not necessarily correspond to designations in the previous figure.

In FIG. 2 block c, transistor Q1 is shown as an n channel field effect transistor, but may represent any appropriate solid state switching device, and is effectively in series between the alternator A and the AC output. It is capable of carrying the full output required for AC out. It is known that transistors of this type with a gate bias on can have very low voltage drops in either conduction in their normal or reverse direction. Conduction in the reverse direction is not only through the body diode, but is also reduced by the rds on of the device. Components C5, D7, C6 & Z4 function as a voltage doubler to produce a voltage across capacitor C6 that is limited by the breakdown voltage of Zener Z4. This voltage is applied to the gate of Q1 to turn that device on through transistor Q2. Q2 is biased on thru resistor R11 connected from its collector to base in the absence of conduction through transistor Q3. Zener diode Z3 & resistor R10 serve to limit what might otherwise be undesirable transients or leakage voltages on the input of transistor Q1. The drive to transistor Q1 may be removed by turning on transistor Q3 allowing current to flow through resistor R12 and diodes D4 & D5. Current through D5 effectively removes the drive from transistor Q2 and diode D4 rapidly bleeds off the charge on the input capacitance of Q1. Capacitor C4 allows a more rapid discharge of the input capacitance of transistor Q1 than would be allowed under steady state conditions thru R12.

In FIG. 2, Block d, if transistor Q8 is not on, then transistor Q7 is turned on by resistor R5 from its collector to base. Thus Q7 supplies current thru diode D1 to the gate of SCR4 allowing it to be turned on when its anode is positive compared to its cathode. Thus SCR4 will rectify the alternator output and charge capacitor C1.

If the voltage on capacitor C1 reaches or exceeds a desired level, the voltage divider including R6, Z2 & R7 will turn on transistor Q8. This will allow current conduction thru diode D2 and remove the base drive from Q7 thus preventing the turn on of SCR4 at the beginning of the next positive cycle thus preventing the voltage on C1 from rising further above the desired voltage. Thus an analog DC regulation circuit controls the DC output at levels which we now define as “DC regulation level A.”

It should be appreciated that one skilled in the art might use the microprocessor in Block a to accomplish what has been described with an analog circuit. The regulated voltage thus created across capacitor C1 is available thru diodes D9 and D10 for the battery charge output or gauge output. If the alternator is operating at sufficiently high rpm to produce a zero to peak voltage above the desired DC output voltage at the gauge or battery charge output, then the current available from these outputs is limited by the alternator capacity and the current carrying capability and forward voltage drop of SCR4 and D9 or D10. Typically at low rpm, when the alternator zero to peak voltage is not sufficient to supply the required DC output considering the forward voltage drops of the semiconductors already mentioned, transistor Q1 is switched off during a selected portion of the positive cycle of alternator a. As herein described, positive may be an instantaneous voltage compared to the ground reference shown. This switching is accomplished by the microprocessor in Block a, driving the components previously described in Block c. Thus the instantaneous open circuit voltage of the alternator is available for charging capacitors C1 and supplying the DC outputs thru SCR4 during the time that transistor Q1 is off and is added to the energy inductively stored in the field associated with the winding of alternator A. Resistor R2, Zener diode Z1, and capacitor C7 supply power to the microprocessor and if the microprocessor does not contain a voltage reference, also a reference voltage for the microprocessor. Voltage divider R3 & R4 supply a signal to the processor at a selected percentage of the voltage across capacitor C1 thus allowing the microprocessor to determine whether transistor Q1 needs to be switched off and for what appropriate interval dependent upon the code program therein. This selected DC voltage level below which Q1 will be intermittently switched off is now defined as “DC regulation Level B”. Diodes D10 and D9 have similar forward voltage drop characteristics, thus the voltage at the gauge and the battery are essentially the same. However, when the engine is stopped, the battery cannot put power back through D9 and end up effectively being discharged by either the gauge unit or the other components within the circuit. Resistors R6 & R7 may be chosen to effectively cancel the temperature coefficient of Zener diode Z2 as compared to the base emitter voltage of transistor Q8. Resistor R1 and capacitor C8 produce an AC phase reference signal into microprocessor U1 so that an appropriate timing for the turn off for transistor Q1 may be made if needed.

By way of example, the circuit of FIG. 2, resulting from testing done to date, produces the lowest degradation of a voltage to the AC loads for a given DC load compared to other known circuits. A particularly advantageous programming of the microprocessor is to turn off transistor Q1 at the peak value of the positive half of the AC waveform under conditions when the DC output (the voltage across C1) is below DC regulation level A. Transistor Q1 may be turned back on a fixed number of electrical degrees such as 30 degrees as an example later or after a fixed period of time or when the voltage across C1 reaches the desired value or a combination thereof. When transistor Q1 is turned off the voltage on C1 may rise slightly above DC regulation level a. This is known as ripple voltage. Therefore the voltage at the next cycle may be sufficiently high such that the microprocessor does not turn Q1 off at all. This could repeat with it being turned off every second cycle or at some other ratio just barely sufficient to supply the output with minimal degradation of the AC output voltage. Block c of FIG. 2 is effectively an AC solid state switch connected between the alternator and the AC load. It should be understood that this AC switch turns off only the positive polarity of the alternator waveform. Thus the negative polarity is always present at the AC output. This switch is normally on and is turned off by a positive signal at the block's effective input terminal that is resistor R13.

Block d is a half wave regulator rectifier for producing a regulated DC output voltage from a varying AC input voltage. Block e is a microprocessor control for producing pulses for turning off block c for the required times to generate the desired output voltage from block d under conditions that the alternator peak voltage is not sufficiently high to produce that voltage from block d in the presence of the AC output load continually connected.

While circuits of the type shown in FIG. 2 have been generally attempted, results have been unsatisfactory in that the AC output would sometimes go to a value well below its AC regulation set point even though the engine was operating at high speed. As a teaching of the present invention, the following explanation for this failure mode may be described as follows.

DC regulation level A and DC regulation level B are controlled by separate references and associated components including voltage dividers and input characteristics of Q8 and L1. All of these components have tolerances and temperature coefficients. Also the phase relationship of the ripple voltage or capacitor Cl compared with when DC regulator level A and DC regulator level B are effectively sensed must be considered when selecting these voltages. If level B, considering all the factors just mentioned exceeds level A, the following may result in low AC output as explained below.

If transistor Q1 is switched off when conducting in its normal direction, for example AC instantaneously positive, and there is no gate current to SCR 4 because DC level a is exceeded, the voltage across the alternator rises rapidly until SCR 2 is turned on because the voltage of Z5 is exceeded. Thus the remainder of that positive cycle is effectively grounded by SCR 2, and sufficient phase shift occurs to lengthen the positive cycle to the point that the AC RMG voltage is greatly reduced. If appropriate preventive measures are not taken, this process may repeat often enough to produce dim headlamps. Preventive measures may include one or more of the following:
1. Assure that DC regulation level is always effectively above DC regulation level b.
2. Allow the generation of a signal to turn off transistor Q1 to occur over only a portion of the engine speed range. As an example if clutch engagement is at 3500 RPM and the alternator is capable of producing rated voltage on all vehicle loads, without switching Q1, at 3500 RPM and above, allow no turn off signal to Q1 above 3500 RPM regardless of the DC output voltage.
3. Allow the generator of a signal to turn off transistor Q1 only above an engine speed where it is assured that supply voltage is available to properly operate the microprocessor L1.

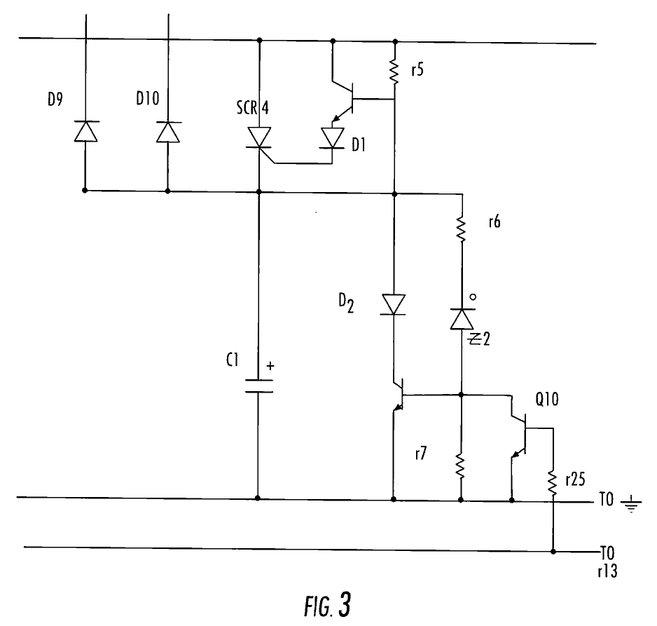

Supplying a gate signal to SCR 4 whenever a signal is present to turn off transistor Q1. A modification of FIG. 2 Block d to accomplish this is shown in FIG. 3 another transistor Q10 is added shown as a NPN. The emitter of Q10 is connected to ground, the collector to the base of Q8, and the base through a resistor R25 to the microprocessor output connected to R13.

Another method may include eliminating R6 and 72 and connecting the base of Q8 through a current limiting resistor to an additional output of the microprocessor. This additional output would be driven low by the programming of the microprocessor whenever (or slightly before) the output to R13 was driven high. As would be understood by one skilled in the art, the microprocessor programming, using data from the R3, R4 divider could supply pulses to the additional output to accomplish the function of “DC regulation level A”.

When this additional output is low, such as when the engine is started, Q8 is off, thus SCR 4 may be gated on through Q7. Thus the microprocessor will have a source of power to start. If startup is too slow compared to possible engine acceleration, Z2 might be retained, but with a selected value to effectively control above “DC regulation level A”.

The circuit of FIG. 3, or the functional equivalent using an additional microprocessor output, as described in above, may have only a single DC regulation level. That is a separate DC regulation level A, and DC regulation level B is not required because SCR4 cannot be off while Q1 is off.

The size and cost of capacitor C1 and the ripple on the DC outputs are factors that would be considered by one skilled in this art. The ripple voltage or capacitor size may be reduced if the microprocessor turns Q1 on, based on the instantaneous voltage from divider R3, R4, before the end of the positive half cycle when Q1 was turned off. Further reduction may be obtained if SCR 4 was replaced by a semiconductor switch capable of turn off by removing a control signal. A transistor in series with a diode is an example of such a switch. At low engine speed, turning Q1 off more than once during a given positive ½ cycle could increase available DC output methods for calculating the Q1 off time based on alternator inductance, current and voltage are well known.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A voltage regulator and control system for supporting a DC voltage regulated to a desired level for a DC load, the system comprising:
a power source having an AC waveform that under some conditions has a peak value below the desired level of the DC voltage;
a first solid state switch connecting the AC waveform to the AC load;
a second solid state switch controlling a magnitude of the DC voltage; and
control means to ensure that the first solid state switch is not turned off unless the second solid state switch is turned on.

2. A voltage regulator and power system for supplying regulated AC and DC voltages, the system comprising:
an alternator separating AC and DC loads, wherein the regulated DC voltage is greater than an alternator zero to peak voltage under some conditions;
an inductor and first solid state switch operable with the alternator;
a control circuit controlling the first solid state switch for transferring energy stored in the inductor to the DC load;
a solid state switch interrupting the flow of current from the alternator to the AC load; and
control means to ensure that the first solid state switch is not turned off unless the second solid state switch is turned on.
